(19) United States
(12) Patent Application Publication
(10) Pub. No.: US 2004/0158972 A1
(43) Pub. Date: Aug. 19, 2004

(54) Method of making a compound magnet

(76) Inventors: Francis M. Creighton IV, St. Louis, MO (US); Peter R. Werp, St. Louis, MO (US)

Correspondence Address: HARNESS, DICKEY, & PIERCE, P.L.C, 7700 BONHOMME, STE 400, ST. LOUIS, MO, 63105, US

(21) Appl. No.: 10/704,195

(22) Filed: Nov. 6, 2003

Related U.S. Application Data
(60) Provisional application No. 60/424,498, filed on Nov. 7, 2002.

(51) Int. Cl. H01F 7/06

(52) U.S. Cl. 29/602.1

(57) ABSTRACT

A method of making a compound magnet that comprises a plurality of regions at least some of which have different magnetization directions. The method comprises assembling a plurality of sections of magnetizable material having a preferred direction of magnetization into a block, each section corresponding to a region or a part of a region, and the preferred magnetization direction of each section being aligned with the desired magnetization direction of its corresponding region. The sections in the assembled block are magnetized to form the compound magnet.

### CROSS-REFERENCE TO RELATED APPLICATIONS

This application claims priority to U.S. Provisional Patent Application No. 60/424,498, filed Nov. 7, 2002, the disclosure of which is incorporated herein by reference.

### BACKGROUND OF THE INVENTION

This invention relates to compound magnets, and in particular to a method of making compound magnets.

A compound magnet is a magnet that has a plurality of regions at least some of which have different magnetization directions. This allows the magnet to have “focused” or improved properties over a magnet in which the magnetization is uniform. For example the magnetic field at a given point can be optimized, so that the compound magnet achieves a greater field strength than a conventional magnet, or at least achieves a greater strength per unit volume. Compound magnets have a number of applications, for example in magnetic surgery systems where one or more magnets is used to create a magnetic field inside the operating region in a patient to control a magnetically responsive medical device, and in magnetic resonance imaging systems. The magnetization direction in the various regions is selected to optimize the desired property.

It would be difficult to make a compound magnet in which the magnetization direction varies from a monolithic block of magnetic material. Presently, compound magnets are made by assembling appropriately shaped sections of material with the appropriate magnetization direction into the final magnet. The sections must be individually manufactured with the correct magnetization direction, and then stored separately so that the do not stick together prior to assembly. Assembly can be a difficult and time consuming procedure because the sections exert attractive and repulsive forces on each other, that increase as the section are brought together. Special jigs are typically required to bring the sections together in the correct positions and orientations, and hold them as the sections are secured together, typically with an adhesive. Significant time and effort is spent placing each section, and the difficulty actually increases as the assembly of the block progresses. Furthermore when assembling magnetized sections, any magnetic material in the vicinity must be carefully managed, to avoid objects being forcefully attracted to, or repelled from, the magnet.

### SUMMARY OF THE INVENTION

The present invention relates to improved methods and apparatus of making compound magnets that have a regions of different magnetization directions. Generally, a preferred embodiment of the method of this invention comprises assembling a plurality of sections of magnetizable material having a preferred direction of magnetization into a block. Each section corresponds to a region or a part of a region, and the preferred magnetization direction of each section is aligned with the desired magnetization direction of its corresponding region; and magnetizing the assembled block to magnetize the sections to form the compound magnet. Generally, a preferred embodiment of the apparatus of this invention comprising a frame for supporting a magnet assembly, a force sensor, and a magnetizer having a bore for receiving the magnet assembly and frame.

### BRIEF DESCRIPTION OF THE DRAWINGS

FIG. 1 is a longitudinal cross sectional view of a compound magnet comprising five regions with different magnetization directions;

FIG. 2 is a longitudinal cross-sectional view of an electromagnetic magnetizer showing a block therein to be magnetized in order to form the compound magnet of FIG. 1;

FIG. 3 is a transverse cross-sectional map of the magnetic field of an optimized superconducting magnet that could be used in the method of this invention;

FIG. 4 is a horizontal longitudinal cross-sectional map of the magnetic field of an optimized superconducting magnet that could be used in the method of this invention;

FIG. 5 is a schematic diagram illustrating the use an applied magnetic field in a single direction to magnetize sections in directions oblique to the direction of the applied magnetic field; and

FIG. 6 is a top plan view of a magnetizer adapted for carrying out the method of this invention;

FIG. 7 is a side elevation view of the magnetizer;

FIG. 8 is an end elevation view of the magnetizer;

FIG. 9A is a perspective view of the magnetizer showing a magnet and a positioning jig;

FIG. 9B is a perspective view of the magnetizer showing a magnet and a positioning jig, on the carriage ready to be introduced into the bore of the magnetizer;

FIG. 10 is an enlarged perspective view of a magnet on a carriage;

FIG. 11 is a top plan view of the magnetizer, with the magnet therein;

FIG. 12 is a side elevation view of the magnetizer, with the magnet therein;

FIG. 13 is an end elevation view of the magnetizer with the magnet therein;

FIG. 14 is a perspective view of the magnetizer with the magnet therein;

FIG. 15 is a front elevation view of an MRI magnet made in accordance with the principles of this invention;

FIG. 15A is a cross-sectional view of the magnet taken along the plane of line 15A-15A in FIG. 15;

FIG. 16A is a perspective view of a magnet in a clamp for supporting the magnet in a magnetizer;

FIG. 16B is a front elevation view of the magnet in the clamp;

FIG. 16C is a side elevation view of the magnet in the clamp;

FIG. 16D is a top plan view of the magnet in the clamp;

FIG. 16E is a exploded view of the magnet and clamp;

FIG. 16F is a perspective view of the magnet in the clamp being inserted into the bore of the magnetizer;

FIG. 16G is partial cross-sectional view of the magnet in the clamp being inserted into the bore of the magnetizer;

FIG. 16H is a vertical cross-sectional view of the magnetizer shown in FIGS. 16F and 16G.

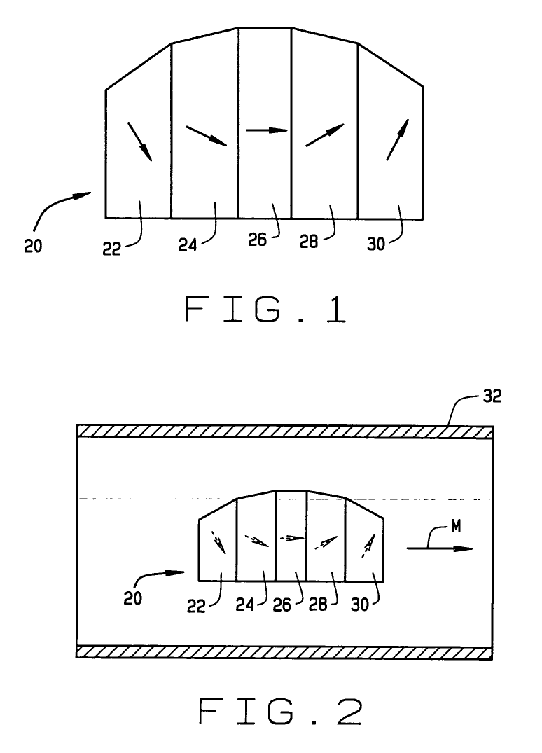

Corresponding reference numerals indicate corresponding parts throughout the several views of the drawings.

### DETAILED DESCRIPTION OF THE INVENTION

This invention relates to a method of making compound magnets, such as magnet 20, which comprises five regions 22, 24, 26, 28 and 30, at least some of which have different magnetization directions indicated generally by solid headed arrows. Because of the varying magnetization directions of each of the five regions, the magnet 20 has enhanced magnetic properties compared to a magnet of similar size and shape, which is magnetized in a uniform direction. For example, the magnet 20 may be designed and constructed to optimize the magnetic field in a particular direction F, at a point spaced from the magnet for use in a magnetic navigation system. Of course the magnet 20 could be optimized for any other magnetic property, if desired, for this or other applications.

Prior to this invention, the magnet 20 would be formed by making sections each corresponding to a region or a portion of a region, and gluing the sections together. However because of the varying magnetization directions, it was difficult to bring the sections together in the desired positions and orientations. It was also difficult to store the sections after they have been magnetized, because of their tendency to attract each other. In accordance with this invention, the sections 22, 24, 26, and 28, and 30 are formed from a material that has a preferred direction of magnetization. One example of such a material is Neodymium 40 BH or 50BH, available from Sumitomo or Shin Etsu. These blocks are manufactured with a preferred magnetization direction of 0° or 30° relative to one of its surfaces. A field of at least about 2.5 Tesla is required to saturate (and magnetize) the material. When a magnetizing field is applied, the material magnetizes in the preferred direction, substantially independent of the direction of the applied magnetizing field. However, the magnetizing field is preferably within 90° of the preferred direction of magnetization, and more preferably within about 60° of the preferred direction of magnetization of the sections in the block

The sections 22, 24, 26, 28 and 30 are assembled before they are magnetized, or at least before they are fully magnetized. This makes it easier to bring the sections together in the proper orientation and position, and to secure the sections together in their proper orientation and position. Once the sections are assembled into a block, the block can be positioned in the bore of magnetizer, such as electromagnet 32. As shown schematically in FIG. 2, the electromagnet 32 applies a magnetizing field in an axial direction indicated by arrow M. The electromagnet 32 is preferably a superconducting electromagnet. The electromagnet 32 preferably has a coil of 36 inches in diameter or larger, so that with the superstructure and cooling components, the working diameter is at least about 34 inches. Of course, the electromagnet could be larger or smaller depending upon the size of the compound magnet 20 being made. The magnetizing field produced by electromagnet 32 magnetizes each section 22, 24, 26, 28, and 30 in its preferred direction.

In designing the magnet 32, it is desirable to minimize winding area to thereby minimize cost of manufacture, however minimizing winding area does not is not optimum to minimize the force generated on the magnet 20 during magnetization. The winding area can be increased in order to generate smaller forces. The greater the forces that can be handled, the smaller the magnet and the lower the cost of the magnetizer. For materials that saturate at about 2.5 T, the field generated by the magnet 32 is at least 5 T, and is preferably at least 6 T. With current technology, it is desirable that the current density be no more than 20 kA/cm² and the field inside the windings must remain below the critical super-conducting field of 8 T. Structurally, the magnet preferably possesses at least a 20 inch inner bore to allow placement of the magnet 20 inside. Where ramping speed is not an issue, a relatively inexpensive power supply can be used.

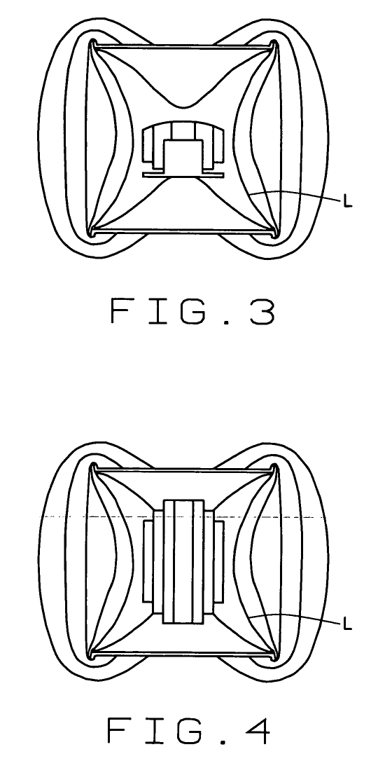

FIGS. 3 and 4 show the block 20 inside the bore of magnet 32, and the dashed line L bounds the region in which the magnetic field is at least 6 T. FIGS. 3 and 4 illustrate that magnet 32 can provide sufficient magnetizing field to all of the block.

As shown in FIG. 5, if the angle between the magnetization direction M and preferred direction of magnetization of the material is θ, and the material saturation is Bₛ, then the magnetization field Bₘ in direction M sufficient to saturate (magnetize) the sections is given by: Bₘ=Bₛ/cos θ. Thus by applying the field Bₘ it is possible to simultaneously magnetize all of the sections 22, 24, 26, 28, an 30 of the block, and form compound magnet 30. For example, if the material saturates at 2.5 T to 3 T, and the maximum angle between the magnetization direction M and preferred direction of magnetization of the material θ is 60° a magnetization field Bₘ of about 5 T to 6 T is sufficient to magnetize the material in its preferred direction.

The sections 22, 24, 26, 28, and 30 are preferably not magnetized before assembly into a block, but the could be partially magnetized in their preferred directions prior to assembly into the block. The blocks can be secured together in any means, but are preferably secured together with adhesive. The magnetizing field is applied in a single direction that is less than about 90° from the preferred direction of magnetization of each section, and more preferably less than about 60° from the preferred direction of magnetization of each section.

The block B is preferably assembled on a base plate P. It is desirable that the block B be precisely positioned in the bore of the magnet 32 so that its weight added to that the base plate P are offset in whole or at least in part by the upwards magnetic force. This results in a balanced system. However, as is with all static magnetic fields, the equilibrium is an unstable one. Whereas a displacement along the axis of the magnetizers results in a restoring force, a radial displacement results in an repelling force away from the axis. Radially, a 0.25 in displacement results in a maximum force increase of roughly 800 lbs. While this force is high, it may be manageable if some simple precautions are taken.

For example, as the block is magnetized, four force sensors could be located above, below, and to the sides of the magnet (gages located on the axis of the magnet 32 are not needed since the magnet tends to stabilize itself in that direction). These would report the forces on the assembly as more current is added to the magnetizer. When the tolerances are reached, hand cranks attached to two translation stages could adjust the magnet so that the force is minimized. Only then would more current be added to the magnetizer. Of course, the entire process could be automated, if desired. As an additional safety precaution, the magnet could be fitted inside a solid drum (plastic, for instance) that would make it impossible to exceed certain threshold forces. Circuitry could also be provided to quench the magnet if the forces violated certain threshold values.

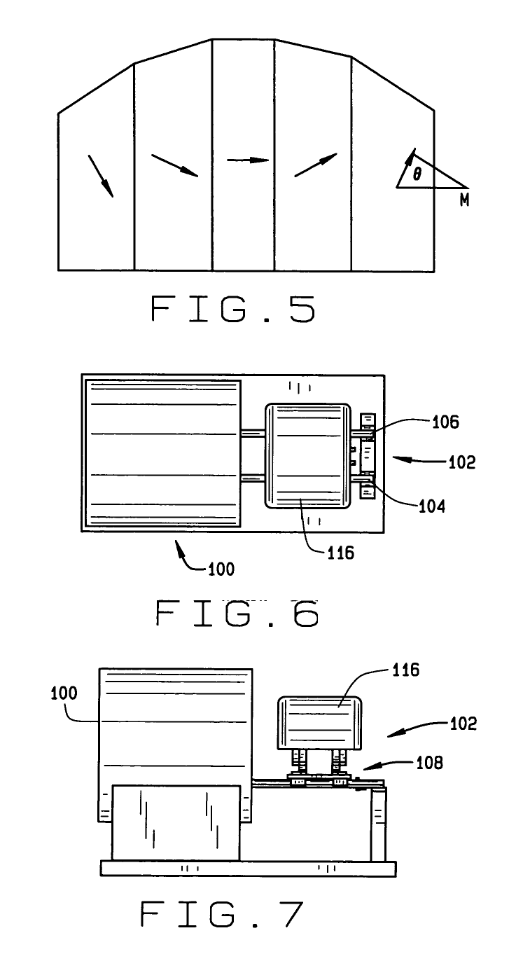

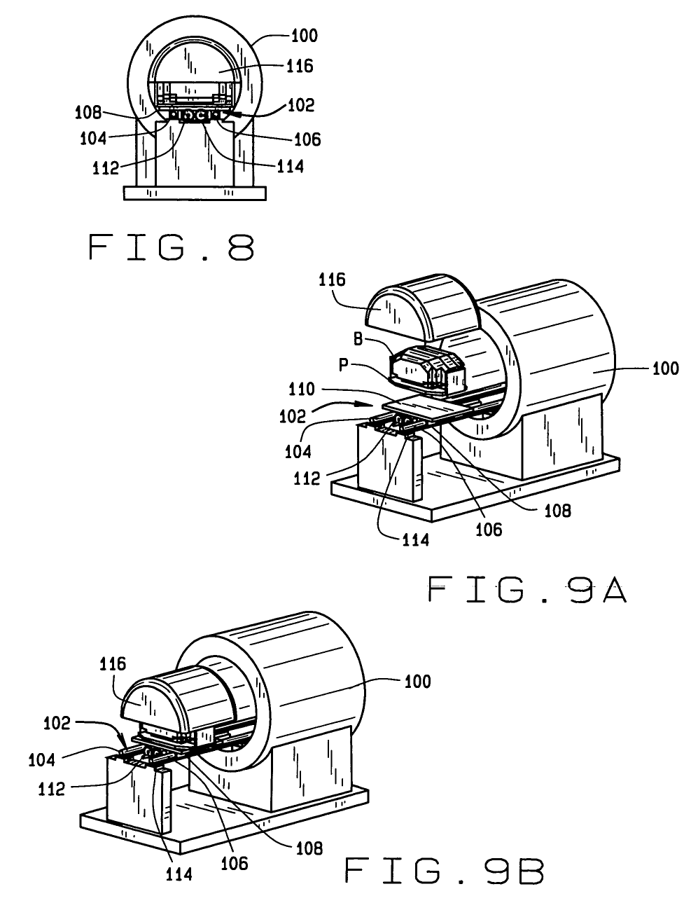

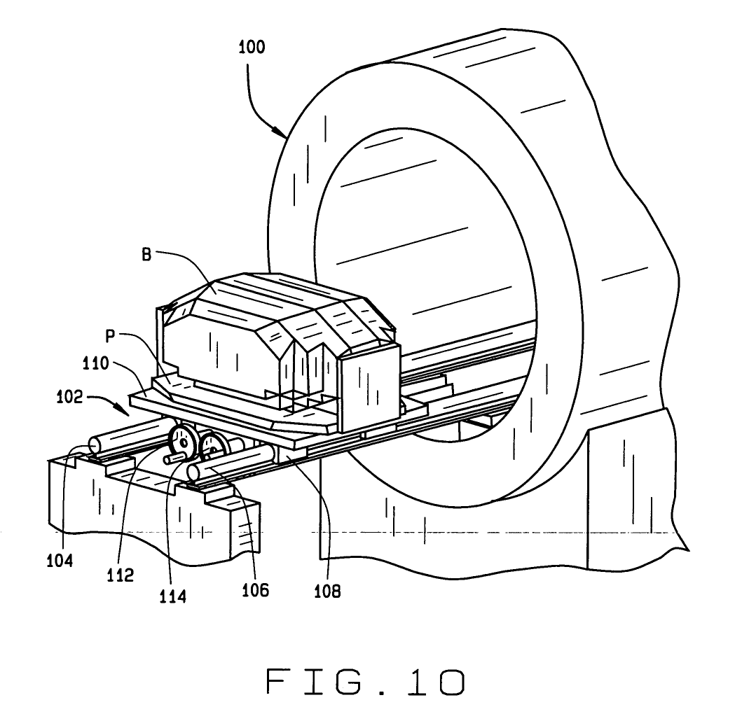

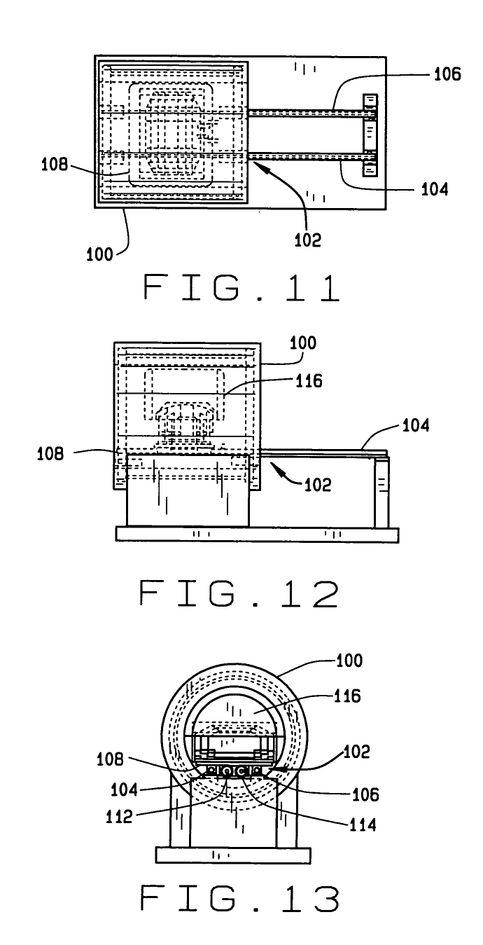

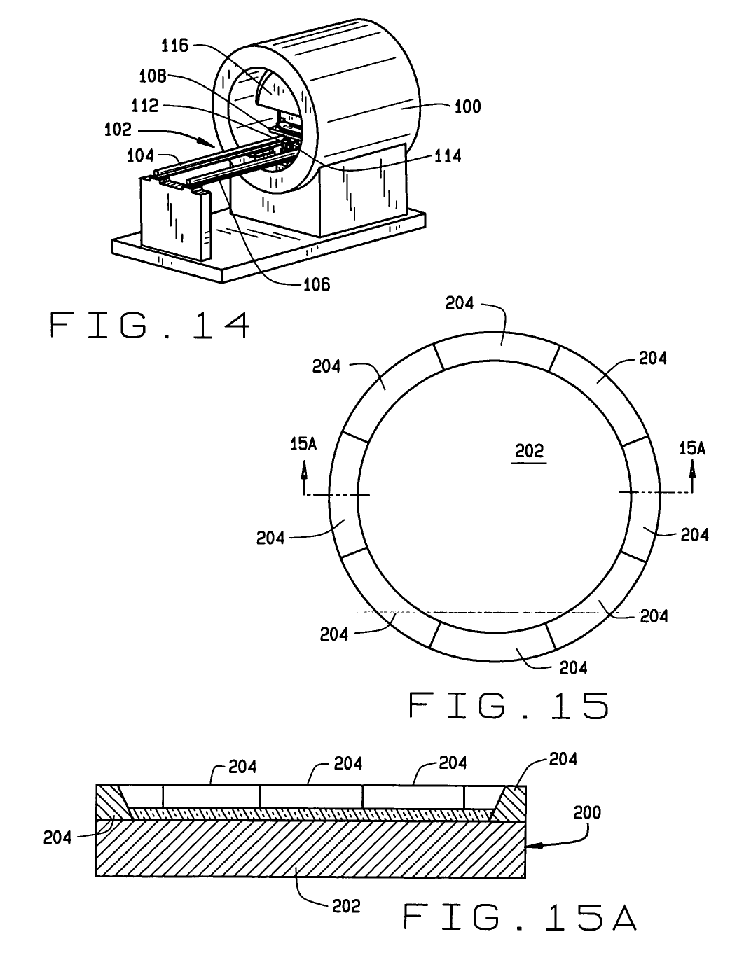

As shown in FIGS. 6-14, the block is preferably positioned inside the coil of an electromagnet. A magnetizer 100 and a positioning system 102 adapted to dynamically adjust the radial position of the block inside the coil, in order to balance the forces between the block and the coils of the magnetizer. In this preferred embodiment the positioning system 102 includes a pair of rails 104 and 106 extending longitudinally into the bore of the magnetizer 100. A carriage 108 is slidably mounted on the rails 104 and 106, and has a surface 110 for supporting the block. The carriage 108 has manual cranks 112 and 114 for operating a positioning system to adjust the position of the surface vertically and horizontally within the magnetizer. A device (not shown) can be provided for measuring the strain applied to the carriage 108, which is proportional to the force on the block. The positioning system allows the position of the block to be adjusted to minimize the strain, and thus the force applied to the block. In another preferred embodiment, the positioning system can be automated to automatically adjust the position of the carriage 108 to minimize the magnetic force on the block. The positioning system preferably allows adjustment of the position of the block in two directions, and preferably two mutually perpendicular direction such as vertically and horizontally. This can help prevent the forces on the block from rising to a level that could be dangerous.

The strain measuring device can be any device for measuring the strain on the carriage. Of course some other force detecting system could be used instead of, or in addition to, the strain gauges. The positioning system can be any mechanical, hydraulic, or other system that is not substantially impaired by, and does not substantially impair, the operation of the magnetizer coil. As shown in the Figures, a jig 116 can be provided around the block, which is sized and shaped to limit the movement of the block inside the magnetizer, to reduce the risk of damage to the magnetizer and/or the block.

The method and apparatus of this invention facilitate the manufacture of compound magnets for magnetic navigation systems. Furthermore, the method and apparatus also facilitate the manufacture of compound magnets for other purposes, including magnets for use in magnetic resonance imaging. Magnets used in magnetic resonance imaging must establish a uniform field, and to reducing “fringing” or curving of the field adjacent the edges of the magnet, magnetic “shims” are provided, sized and shaped to help maintain the field uniformity adjacent the edges. An example of such a magnet 200 is shown in FIG. 15. It can require considerable effort and expense to assemble a magnetized shim onto the magnet in the proper direction and orientation. However, in accordance with the present invention, the magnet sections and shim section can be assembled before they are fully magnetized. As shown in FIGS. 15 and 15A, the assembled block 200 can comprise a base section 202, and a plurality of shim sections (e.g. 204 and 206) forming magnetic shims for improving the magnetic field direction adjacent the edges of the completed magnet. The base section 202 and the shims 204 and 206 are arranged with their preferred magnetization directions oriented in the desired magnetization direction and the assembled block, with sections of different magnetization directions, and then be magnetized by applying a single uniform field direction. Thus a magnet for a magnetic resonance imaging system can be made of one block comprising multiple sections and magnetized, or of several blocks, each comprising multiple sections, and magnetized and assembled. In other words, all of the sections for forming the magnet can be assembled together before magnetization, or the sections forming the magnet as assembled into at least two different preassemblies each comprising multiple sections, and these preassemblies can magnetized before being assembled into the completed magnet.

Thus, according to the method of this invention, a compound magnet is assembled from a plurality of sections. Because the sections are not magnetized, or are only partially magnetized, the blocks are relatively easy to position and orient and secure together. The sections can then be magnetized simultaneously by applying a magnetic field. The blocks are magnetized in their preferred magnetization directions. This method also allows magnets to be remagnetized.

This also allows assembled, but unmagnetized, blocks to be assembled remotely, and transported in an unmagnetized state. This reduces problems of shielding the compound magnet during storage and shipment. This method also allows a magnet to be decommissioned by placing the magnet in the bore of an electromagnet, and applying a magnetic field opposite to the magnetizing field to demagnetize the magnet so that it can be safely disposed of, or recycled.

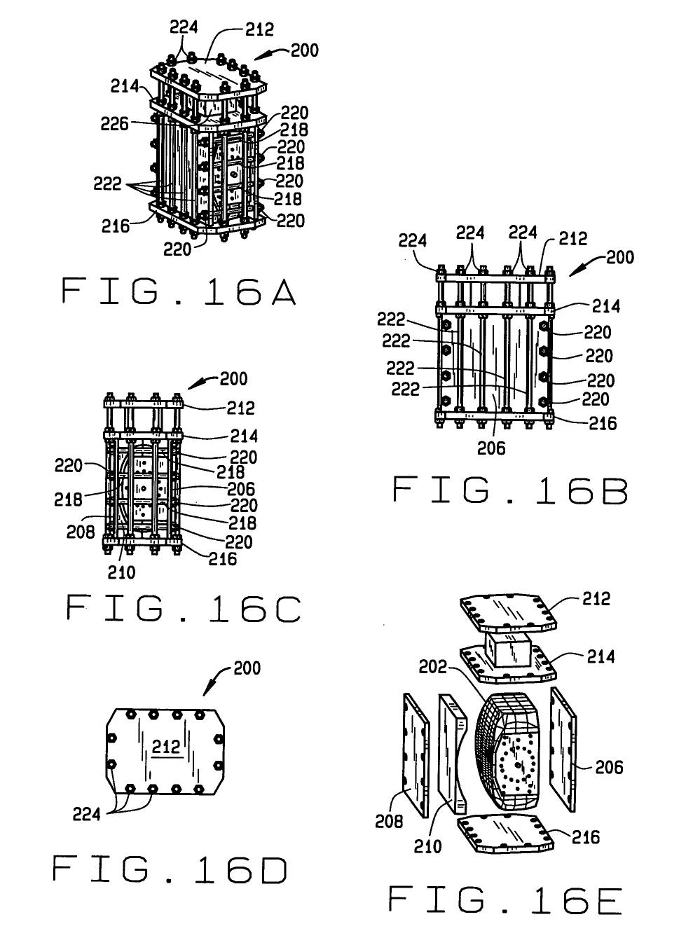

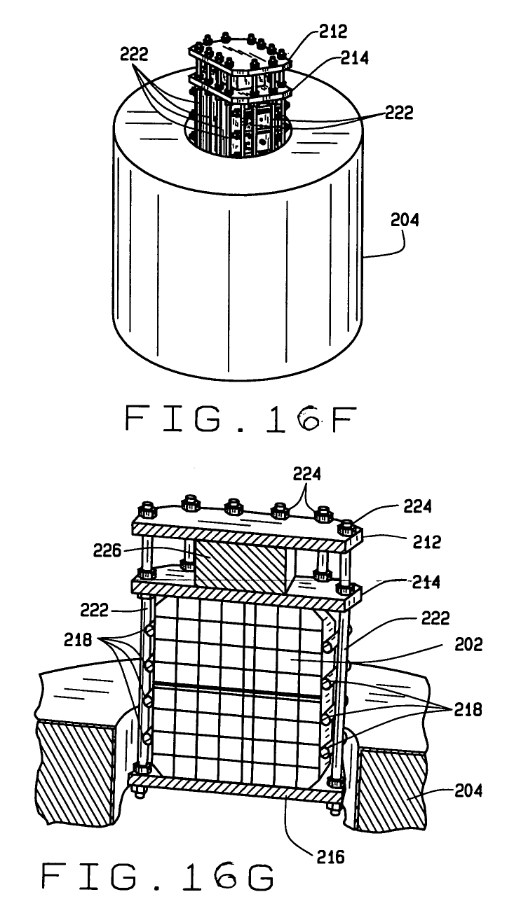

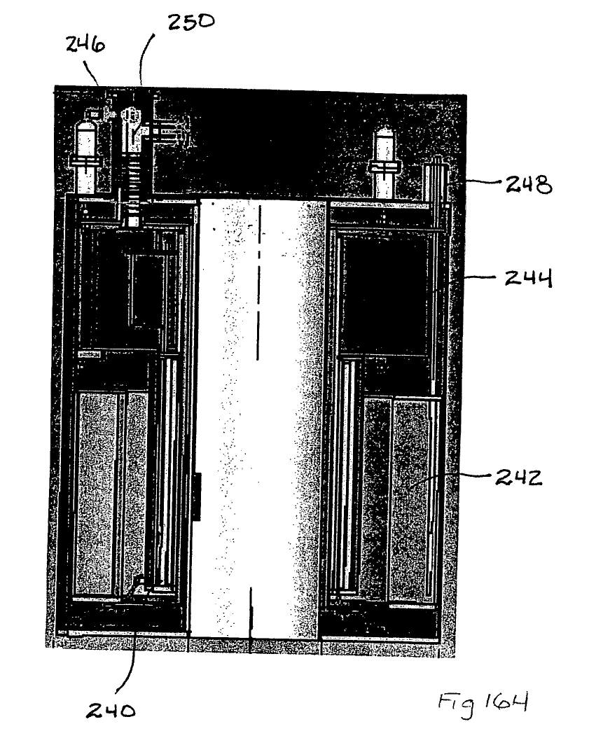

A preferred embodiment of a frame 200 for supporting a magnet assembly 202 during magnetization in a magnetizer 204 is shown in FIGS. 16A-16G. As shown in the Figures, the frame 200 comprises a front plate 206, a back plate 208, a contoured shim 210 for receiving the contoured back face of the magnet assembly. The frame further comprises a top plate 212, an intermediate plate 214, and a bottom plate 216. The front plate 206 and the back plate 208 are joined by rods 218 with threaded ends, and nuts 220 on the threaded ends, sandwiching the magnet assembly 202 and the ship 210 between them. Similarly top plate 212, the intermediate plate 214, and the bottom plate 216 are joined by rods 222 with threaded ends, and nuts 224, sandwiching a load cell 226 between to the top and intermediate plates 212 and 214, and sandwiching the magnet assembly 202 between the intermediate and bottom plates 214 and 216.

The corners of the top, intermediate, and bottom plates 212, 214, and 216 are beveled so that the magnet assembly and frame can fit in the bore of a magnetizer.as best shown in FIG. 16G, the frame supports the magnet assembly in the magnetizer. Before the magnet assembly is magnetized, the forces between the sections of material comprising the magnet assembly are relatively low. As shown in FIGS. 16F and 16G, the magnet body can be relatively simply and easily lowered by a hoist into a vertically oriented bore of a magnetizer. However, after the magnet assembly has been magnetized, the forces between sections can be extremely high. In some cases sufficiently high to cause failure of the adhesive joining adjacent sections, and more rarely failure of the sections themselves. The frame 200 helps hold the magnet assembly together after magnetization, reducing the risk of magnet material being propelled from the assembly. The load cell 226 detects forces on the frame 220 indicative of failure of the magnet assembly. Thus when the magnetized magnet assembly is removed from the bore of the magnetizer, the load cell indicates whether any sections in the magnet assembly have separated or failed, so that appropriate precautions can be taken. Rather than load cells, rather than pressure sensors, the frame 220 could be equipped with strain gauges for measuring strain of the frame, to determine whether the magnet assembly is exerting abnormal forces against the frame.

A possible construction of the magnetizer 204 is shown in FIG. 16H. The magnetizer 204 comprises a superconducting electromagnetic coil 240, surrounding a hollow core for receiving the magnet assembly to be magnetized. The magnetizer further comprises reservoirs 242 for liquid nitrogen, and 244 for liquid helium to maintain the coil in superconducting status. A current lead 246 is provided to connect the coil 240 to a source of electric current. The magnetizer includes a port 248 for supplying liquid helium to the reservoir 244, and a port 250 for supplying liquid nitrogen to the reservoir 242. The entire magnetizer is thermally insulated to maintain the coil 240 in superconducting status.

What is claimed is:

1. A method of making a compound magnet that comprises a plurality of regions at least some of which have different magnetization directions, the method comprising assembling a plurality of sections of magnetizable material having a preferred direction of magnetization into a block, each section corresponding to a region or a part of a region, and the preferred magnetization direction of each section being aligned with the desired magnetization direction of its corresponding region; and magnetizing the assembled block to magnetize the sections to form the compound magnet.

2. The method according to claim 1 wherein the sections are partially magnetized in their preferred directions prior to assembly into the block.

3. The method according to claim 1 wherein adjacent sections are secured together with an adhesive.

4. The method according to claim 1 wherein the step of magnetizing the assembled block comprises applying a magnetizing field to the block.

5. The method according to claim 1 wherein the magnetizing field is applied in a single direction that is less than about 90° from the preferred direction of magnetization of each section.

6. The method according to claim 1 wherein the magnetizing field is applied in a single direction that is less than about 60° from the preferred direction of magnetization of each section.

7. The method according to claim 1 wherein the magnetizing field is applied to the block by positioning the block inside a superconducting electromagnetic coil.

8. The method according to claim 7 further comprising dynamically adjusting the radial position of the block in the bore to control the forces on the block.

9. The method according to claim 8 further comprising measuring the forces between the electromagnetic coil and the block and adjusting the position of the block within the electromagnetic coil based on these measured forces.

10. The method according to claim 9 wherein the block is held on a support in the electromagnetic coil, and wherein the step of measuring the forces comprises using strain gauges on the support.

11. The method according to claim 1 wherein all of the sections forming the magnet are assembled together before magnetization.

12. The method according to claim 1 wherein the sections forming the magnet as assembled into at least two different preassemblies each comprising multiple sections, and wherein the preassemblies are magnetized before being assembled into the completed magnet.

13. A method of making a compound magnet that comprises a plurality of regions at least some of which have different magnetization directions, the method comprising assembling a plurality of sections of magnetizable material into a block, each section corresponding to a region or a part of a region, and having a preferred direction of magnetization which is aligned with the desired magnetization direction of its corresponding region; and magnetizing the assembled block to magnetize each section in its preferred magnetization direction to form the compound magnet.

14. The method according to claim 13 wherein the assembled block is secured in a frame before magnetization.

15. The method according to claim 14 further comprising measuring the force on the frame after magnetization to determine whether there the assembled block has failed.

16. The method according to claim 15 wherein the frame includes at least one load cell, and wherein measuring the force on the frame after magnetization employs the at least one load cell.

17. The method according to claim 15 wherein the frame includes at least one strain gauge, and wherein measuring the force on the frame after magnetization employs to strain gauge to determine the level of force exerted by the magnet assembly on the frame.

18. Apparatus for making a compound magnet that comprises a plurality of regions at least some of which have different magnetization directions, the apparatus comprising a frame for surrounding a block assembled a plurality of sections of magnetizable material, the frame including at least one force sensor; and a electromagnet having a bore adapted to receive the frame and block, and applying a magnetic field in a single direction of sufficient strength to magnetize each section in the block in its preferred magnetization direction to form the compound magnet.

19. The apparatus according to claim 18 wherein the at least one force sensor is at least one load cell.

20. The apparatus according to claim 18 wherein the at least one force sensor is at least one strain gauge.
